(19) United States
(12) Patent Application Publication
(10) Pub. No.: US 2005/0003841 A1
(43) Pub. Date: Jan. 6, 2005

(54) Method, system and terminal for synchronising a plurality of terminals

(76) Inventors: Juha Salo, Littoinen (FI); Janne Aaltonen, Turku (FI)

Correspondence Address: Morgan & Finnegan, 345 Park Avenue, New York, NY, 10154-0053, US

(21) Appl. No.: 10/485,774

(22) PCT Filed: Aug. 3, 2001
(86) PCT No.: PCT/EP01/09639

(51) Int. Cl. H04B 7/01

(52) U.S. Cl. 455/502

(57) ABSTRACT

The present invention relates to the synchronisation of terminals and, more particularly, to the synchronisation of multiple terminals in a multi-user environment. According to one embodiment of the present invention there is provided a method for synchronising a plurality of remote user terminals capable of communicating with a remote host, wherein one of the user terminals creates update data to be transmitted to the other ones of the plurality of user terminals, comprising: receiving at the remote host, via a first telecommunications network, update data from one of the plurality of remote user terminals; and transmitting, via a second telecommunications network, a signal based on the received update data to the other ones of the plurality of user terminals thereby synchronising the user terminals.

The present invention relates to the synchronisation of terminals and, more particularly, to the synchronisation of multiple terminals in a multi-user environment.

Use of the Internet is widespread, with users having, typically, dial-up or other point-to-point connections to an Internet service provider which provides access to the Internet.

The number of applications and services available via the Internet is vast, and includes such diverse areas as on-line shopping, news, banking, chat rooms, and games. Many of these services are individual based, for example on-line banking, whilst others, such as games and chat rooms take advantage of the huge Internet population to allow many people from all corners of the globe to interact, share data, chat and play together.

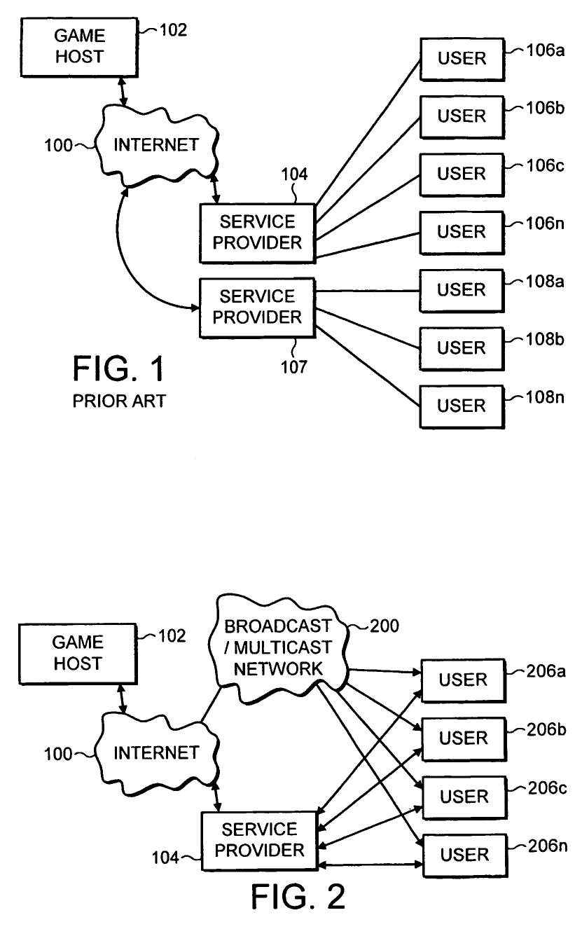

FIG. 1 is a block diagram of a system according to the prior art. Service providers 104 and 107 provide access to the Internet 100 from a number of user terminals 106a to 106n and 108a to 108n respectively. The user terminals typically connect to their respective service provider using dial-up connections to a telecommunication network, such as the public telephone network. In order to send and receive data, the connection between each user and the service provider must be maintained.

For the purposes of explanation take, for example, the case of a typical First-Person Shooter (FPS) game, such as Quake™ or Doom™. Such games allow multiple users to interact in real-time in a virtual-reality type environment. A number of users 106a to 106n and 108a to 108n connect, via their respective service providers 104 and 107, to a game host 102. Typically the game application resides on each user terminal and the game host 102 manages and distributes data relating to the location, status, etc of each player. For example, if the user 106a moves his character (herein referred to as a user update) this information is sent back to the game host via the dial-up connection, to the service provider, across the Internet and finally to the game host. The game host must then send this user update data to all the other users 106b to 106n and 108a 108n so that the game environment on each of the user terminals is up-to-date and synchronised. This scenario causes a huge amount of duplicated data to be transmitted by the service providers to each of the individual users. Any delay in the data being sent between the game host and the user can severely reduce the playability of such games, as each of the user terminals can quickly become out of synchronisation with each other. Delays, however, are common place in the Internet, especially where users connect to their service providers via relatively slow modem links.

Accordingly, one aim of the present invention is to improve the usability of such multi-user applications.

According to a first embodiment of the present invention there is provided a method for synchronising a plurality of remote user terminals capable of communicating with a remote host, wherein one of the user terminals creates update data to be transmitted to the other ones of the plurality of user terminals, comprising: receiving at the remote host, via a first telecommunications network, update data from one of the plurality of remote user terminals; and transmitting, via a second telecommunications network, a signal based on the received update data to the other ones of the plurality of user terminals thereby synchronising the user terminals.

According to a second embodiment of the present invention there is provided a system for synchronising a plurality of remote user terminals capable of communicating with a remote host, wherein one of the user terminals creates update data to be transmitted to the other user terminals comprising: receiving at the remote host, via a first telecommunications network, update data from one of the remote user terminals; transmitting, via a second telecommunication network, a signal based on the received update data to the user terminals thereby synchronising the user terminals.

According to a third embodiment of the present invention there is provided a user terminal capable of remotely synchronising with a remote user terminal, wherein each user terminal is capable of communicating with a remote host, comprising: a transmitter for transmitting, via a first telecommunications network, update data to the remote host; and a receiver for receiving, via a second telecommunications network, update data transmitted by the remote host.

The invention will now be described, by way of example only, with reference to the accompanying diagrams, in which:

FIG. 1 is a block diagram of a system according to the prior art;

FIG. 2 is a block diagram of a system according to one embodiment of the present invention;

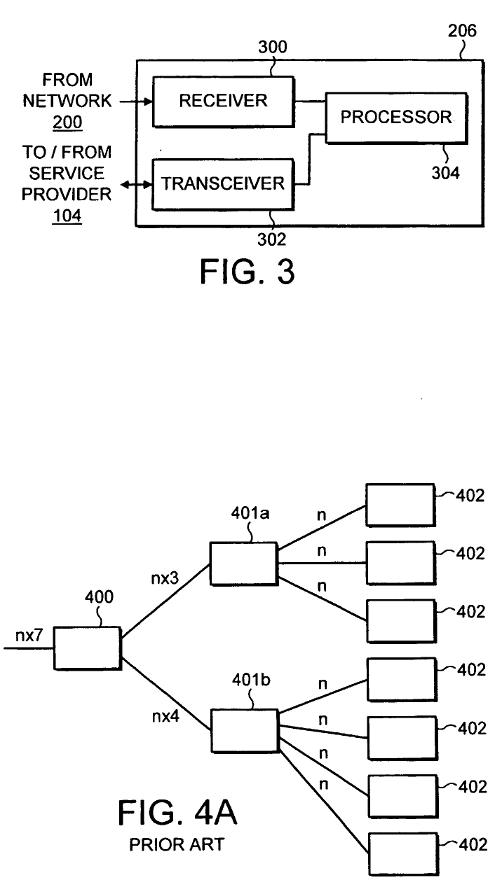

FIG. 3 is a block diagram of a user terminal according to the present invention; and

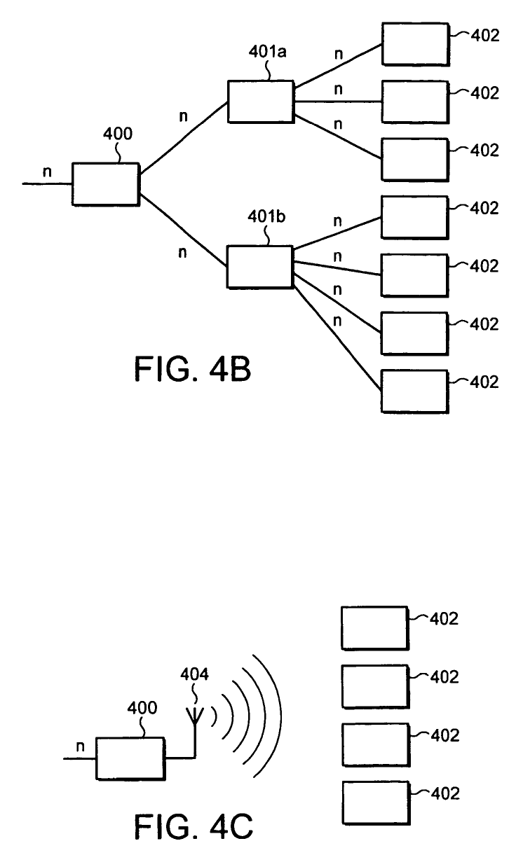

FIG. 4 shows a number of block diagrams to further emphasise how the present invention improves system performance compared to the prior art.

FIG. 2 is a block diagram of a system according to one embodiment of the present invention. The system of FIG. 2 shares some common features with the system of FIG. 1, and like elements are numbered the same. For clarity, however, only a single service provider 104 is shown. As before, a number of users can connect, via their user terminals 206a to 206n to service provider 104, across the Internet 100 to the game host 102. As previously described, this connection is typically by way of a dial-up or other point-to-point connection, such a large or wide area network, asynchronous digital subscriber line (ADSL), general packet radio system (GPRS) etc. A point-to-point connection is typically a bi-directional channel and may be either a physical communication channel, or a virtual or logical communication channel.

In addition there is provided a broadcast or multicast network 200. The basic concept of the invention is that a user update is sent from a user terminal to the game host 102, as before. However, when sending the user updates to all of the other users, the game host routes the user update via a broadcast or multicast network 200. The broadcast or multicast channel enables each user update to be transmitted only once, but enables many terminals to receive the user update. This advantageously reduces the amount of data which needs to be transmitted in order to ensure that all the user terminals are in possession of the same information.

This ensures that all the user terminals are synchronised with one another. Synchronisation means that all the user terminals are in possession of the most recent user updates from all users, which is essential in a real-time multi-player game environment. In other contexts, such as in a chat room, synchronisation means that all the user terminals have the latest thread of conversation, allowing any user to instantly respond to the on-going chat.

The use of a broadcast or multicast network ensures that synchronisation occurs with the shortest possible delay, with a minimum amount of data traffic being created. The network 200 may be, for example, a digital video broadcast network, a cellular network, a user datagram protocol over Internet protocol network (UPD/IP), or any other suitable medium. Each of the user terminals is adapted to receive data from the network 200, as well as to connect with the service provider 104. In this way, only user updates are transmitted over dial-up connection to the game host, freeing up bandwidth in the Internet as well as the service provider's dial-up servers.

A user update is typically generated by a user terminal, or may be received by auxiliary equipment connected to the user terminal. A user update may be generated in relation to any kind of environment in which the user terminals participate. For example, a user update may be in relation to a game move in a multi-player gaming environment, may be a response to a text-based chat room environment, or may be in relation to any kind of entertainment based environment.

The present invention is particularly advantageous for application of so-called chat rooms. In chat rooms, users post messages etc to a chat room server which displays the messages for other users to see. Typically, chat rooms operate in a quasi real-time environment, whereby users can respond to displayed messages by sending new messages, much like having a written conversation. Users of chat rooms often spend the majority of the time watching and reading the messages posted by other users, and may only respond occasionally by posting a message. With the prior art system of FIG. 1, even whilst not actively participating in the chat room, a user must maintain a point-to-point connection with the service provider in order to monitor the responses posted by other users. This not only unnecessarily ties up dial-up servers at the ISP, but also the users typically incur charges whilst a point-to-point connection is maintained.

The term user update used herein refers to any kind of data which is needs to be disseminated to other user terminals. For example, in a multi-player game scenario, a user update could be a game move, status information, player location information etc. In a chat room scenario, a user update could be a text-based reply to a conversation thread.

FIG. 3 is a block diagram of a user terminal according to an embodiment of the present invention. A user terminal 206 comprises a receiver 300 for receiving signals from the network 200. Additionally, a transceiver 302 is used to connect to the service provider 104. The transceiver may be a modem, for providing a dial-up connection to the service provider, or alternatively may be a network adapter for connecting to the service provider using Ethernet, wireless LAN, ADSL, ISDN, or any other suitable alternative apparent to those skilled in the art. The receiver 300 and the transceiver 302 are controlled by a processor 304. The skilled person will be aware that there are many additional functions associated with such a user terminal, including user interface, display etc.

The advantages of the present invention are highlighted below with reference to an exemplary scenario of a multi-player game having 1000 players. The following example ignores the extra data generated by communications protocols for error protection, routing headers etc.

Assume that each player makes one game move (user update) per second, and the amount of data generated for each move is 10 bytes.

In the prior art system, wherein each user is connected via a point-to-point or dial-up connection, the total amount of data generated by the users and sent to the game host=1000 users*10 bytes=10 kBytes/sec, for one game move.

The total amount of data generated by the game host and transmitted to all the 1000 users=1000 users*10 kBytes=10 Mbytes/sec.

In the system according to the present invention, the data generated by the all the users is the same at 10 kbytes/sec. However, to transmit this information from the game host to all 1000 users only requires a bandwidth of 10 kbytes/sec.

In this example the system according to the present invention is 1000 times more efficient than the system of the prior art. Additional benefits are that it is generally more cost effective to broadcast large amounts of data than to supply that data to multiple users via point to point connections. Furthermore, congestion on the Internet is reduced since the user updates are not transmitted via the Internet.

In yet a further embodiment of the present invention a router (not shown) may be used by the game host to determine the most efficient way of distributing the user updates to the users. For example, if there is a local concentration of users, for efficiency the router may (providing the user terminals support it) use, for example, a GSM broadcast channel. Alternatively, if the users are distributed over a wide area, the router may decide to use a satellite broadcast channel, such as DVB, or a terrestrial broadcast channel, such as DVB-T. Additionally, the router may also route the data through different distribution channels depending on the location and capabilities of individual user terminals. For example, some users may receive the data via a GSM network, whilst other users may receive the data via a DVB-T network. To increase flexibility user terminals may optionally be capable of receiving data over more than one type of communication channel. Additionally, the communication channel may dynamically change depending on certain parameters of the communication channel. For example, if it is detected that a user terminal is out of range of a GSM transmitter, the user terminal may switch to receive data via a DVB-T or other network.

FIG. 4 shows a number of block diagrams to further emphasise how the present invention improves system performance compared to the prior art. FIG. 4a shows a block diagram according to the prior art. A number of routers 400 and 401 are used to route data to a number of user terminals 402. In this example, there are seven user terminals receiving a user update. The router 400 receives seven data packets n containing identical user update data for delivery to each of seven different user terminals. The router 400 routes three of these packets to the router 401a and routes four of these packets to the router 401b. Each of the routers 401 then routes an individual packet to each of the respective user terminals 402. It is clear from this example that seven identical packets are sent around the network, causing network congestion and taking up valuable bandwidth.

FIG. 4b shows a block diagram according to one embodiment of the present invention using a multi-cast approach. Each of the user terminals 402 are part of a defined multi-cast group. The router 400 receives a single packet of data n which has a multi-cast header. The routers 401 receive this single packet and route it to the user terminals 402. In this example, the use of multi-cast significantly reduces the amount of data within the network, although each of the user terminals requires a connection to their corresponding router for the final stage of the data delivery.

Finally, FIG. 4c shows a block diagram according to a further embodiment of the present invention using a broadcast approach. Like elements are given the same reference numerals as in FIG. 4b. By broadcasting the user update information via a broadcast network 404 further significantly reduces the amount of data in the Internet network. A packet n is receiver by a router 400 which broadcasts the packet n using an appropriate broadcast network, as described above. In this way, a single transmission of the packet n is sufficient for all user terminals to receive the packet n. Since the packet n is transmitted via a broadcast network, it is not unnecessarily transmitted through the Internet, thereby reducing congestion.

The game host may operate in a number of different ways which can be tailored to maximise the efficiency of the present invention in each scenario. For example, in a rapidly moving game environment, the game host may transmit user updates as soon as they are received by a user terminal. However, in environments where speed is not important, for example a card-game, the game host may wait until all active participants have created a user update before transmitting the user update. In other embodiments, the game host may wait for a certain number of user updates to be received before transmitting them. The number of user updates may vary depending on specific implementations of the multi-user environment. For example, in a game with 100 participants, the game host may be arranged to transmit the user updates as soon as user updates have been received from 50 of the participants.

A further example of how the present invention may be used is described below. Go Game (also known as Weich'i) is an ancient Chinese board game which is played extensively throughout the world. Go is a game of tactics and strategy played by two players. Players take turns at placing markers (‘stones’) on an initially empty board (‘goban’), following simple rules. On the Internet, games may be followed by many spectators eager to learn and improve their game by following more highly skilled players in action. Using the embodiments of the present invention described above, Go Game may be played by two players and followed by spectators all over the world, whilst minimising the amount of data generated and distributed through the Internet. Game moves (user updates) will be generated by each of the two players as they place their stones on the board. The user updates are then distributed to the other player and also to any spectators wishing to follow the game.

The present invention may be used in many different situations, and is ideally, although not exclusively, suited to situations which require many remote user terminals to be synchronised to one another.

Although the invention is herein described with reference to the Internet, those skilled in the art will appreciate that the invention is not limited thereto. The concepts of the present invention may be applied to many other network environments and configurations including private access networks, intranets, etc.

1. A method for synchronising a plurality of remote user terminals capable of communicating with a remote host, wherein one of the user terminals creates update data to be transmitted to the other ones of the plurality of user terminals, comprising:
receiving at the remote host, via a first telecommunications network, update data from one of the plurality of remote user terminals; and
transmitting, via a second telecommunications network, a signal based on the received update data to the other ones of the plurality of user terminals thereby synchronising the user terminals.

2. The method of claim 1, wherein the step of transmitting comprises routing the transmission of the signal to the user terminals via different networks depending on parameters of each user terminal.

3. The method of claim 2, wherein the parameters of each user terminal are based on the location of the user terminal.

4. The method of claim 2, wherein each user terminal is adapted to receive update data over a number of different telecommunications networks and further wherein the parameters of each user terminals are based on the type of different telecommunications networks supported by that user terminal.

5. The method of claim 1, wherein the first telecommunication network is a point-to-point network.

6. The method of claim 1, wherein the second telecommunication network is a broadcast network.

7. The method of claim 1, wherein the second telecommunications network is a multicast network.

8. A system for synchronising a plurality of remote user terminals capable of communicating with a remote host, wherein one of the user terminals creates update data to be transmitted to the other user terminals comprising:
receiving at the remote host, via a first telecommunications network, update data from one of the remote user terminals;
transmitting, via a second telecommunication network, a signal based on the received update data to the user terminals thereby synchronising the user terminals.

9. The system of claim 8, wherein the remote host comprises a router for transmitting the signal to the user terminals via different networks depending on parameters of each user terminal.

10. The system of claim 8 wherein the first telecommunications network is a point-to-point network.

11. The system of claim 8, wherein the second telecommunications network is a broadcast or multicast network.

12. A user terminal capable of remotely synchronising with a remote user terminal, wherein each user terminal is capable of communicating with a remote host, comprising:
a transmitter for transmitting, via a first telecommunications network, update data to the remote host; and
a receiver for receiving, via a second telecommunications network, update data transmitted by the remote host.

13. The user terminal of claim 12, wherein the first telecommunication network is a point-to-point network.

14. The user terminal of claim 12, wherein the second telecommunication network is a broadcast network.

15. The user terminal of claim 12, wherein the second telecommunication network is a multicast network.

16. (Cancelled)

17. (Cancelled)

18. (Cancelled)

19. (Cancelled)
